(19) United States
(12) Patent Application Publication
(10) Pub. No.: US 2024/0286653 A1
(43) Pub. Date: Aug. 29, 2024

(54) MAGNETIC LEVITATION TRANSPORT SYSTEM AND MAGNETIC LEVITATION TRANSPORT METHOD USING THE SAME

(71) Applicant: Samsung Display Co., LTD., Yongin-si (KR)

(72) Inventors: BEOMJAE KIM, Yongin-si (KR); MINGYOUN KANG, Yongin-si (KR)

(21) Appl. No.: 18/514,039

(22) Filed: Nov. 20, 2023

(30) Foreign Application Priority Data
Feb. 24, 2023 (KR) 10-2023-0025231

(51) Int. Cl. B61B 13/08

(52) U.S. Cl. CPC B61B 13/08

(57) ABSTRACT

A magnetic levitation transport system includes: a first magnetic screw including a first end and a second end, which are opposite to each other; and a second magnetic screw disposed in one direction from the first magnetic screw and including a third end and a fourth end, which are opposite to each other, where the third end is disposed farther from the first magnetic screw than the fourth end is disposed. An angle of the fourth end is determined based on an angle of the first end.

This application claims priority to Korean Patent Application No. 10-2023-0025231 filed on Feb. 24, 2023, and all the benefits accruing therefrom under 35 U.S.C. § 119, the content of which in its entirety is herein incorporated by reference.

### BACKGROUND

### 1. Field

Embodiments relate to a magnetic levitation transport system. More specifically, embodiments relate to a magnetic levitation transport system and a magnetic levitation transport method using the same.

### 2. Description of the Related Art

As information technology develops, the importance of a display device, which is communication media between users and information, is being highlighted. Accordingly, the display device such as a liquid crystal display device, an organic light emitting display device, a plasma display device, or the like is widely used in various fields.

The display device may be manufactured through processes each performed in a process chamber. In this case, a carrier may be used to transfer a substrate of the display device to each process chamber. The carrier may transfer the substrate to each chamber or transfer the substrate within the chamber.

### SUMMARY

Embodiments provide a magnetic levitation transport system with improved efficiency.

Embodiments provide a magnetic levitation transport method using the magnetic levitation transport system.

A magnetic levitation transport system according to an embodiment of the present disclosure includes: a first magnetic screw including a first end and a second end which are opposite to each other; and a second magnetic screw disposed in one direction from the first magnetic screw and including a third end and a fourth end, which are opposite to each other, where the third end is disposed farther from the first magnetic screw than the fourth end is disposed. An angle of the fourth end is determined based on an angle of the first end.

In an embodiment, when the angle of the first end is a reference angle 0°, an angle of the second end may be calculated using following Equation 1: a=L1/P1*(−360). In Equation 1, “a” may be the angle of the second end, L1 may be a length of the first magnetic screw, and P1 may be a pitch of the first magnetic screw. When an angle of the third end is reference angle 0°, the angle of the fourth end may be calculated using following Equation 2: b=L2/P2*(−360). In Equation 2, “b” may be the angle of the fourth end, L2 may be a length of the second magnetic screw, and P2 may be a pitch of the second magnetic screw.

In an embodiment, when the first magnetic screw rotates, a rotation angle of the second magnetic screw may be calculated using following Equation 3: c=x+t/P*360. In Equation 3, “c” may be the angle of the fourth end, “x” may be the angle of the first end, “t” may be a distance between the first magnetic screw and the second magnetic screw, and P may be the pitch of each of the first magnetic screw and the second magnetic screw, and the pitch of the second magnetic screw may be the same as the pitch of the first magnetic screw.

In an embodiment, the magnetic levitation transport system may further include an angle sensor connected to each of the first end and the third end.

In an embodiment, the magnetic levitation transport system may further include a motor connected to each of the second end and the fourth end.

In an embodiment, the magnetic levitation transport system may further include a magnetic nut movable in the one direction on the first magnetic screw and the second magnetic screw.

In an embodiment, the magnetic levitation transport system may further include a carrier connected to the magnetic nut.

In an embodiment, the magnetic levitation transport system may further include a first chamber and a second chamber disposed in the one direction from the first chamber. The first magnetic screw may be disposed in the first chamber, and the second magnetic screw may be disposed in the second chamber.

In an embodiment, each of the first magnetic screw and the second magnetic screw may include a magnet forming an outer surface.

In an embodiment, the magnet may include a south pole and a north pole alternately arranged along the one direction.

A magnetic levitation transport method according to an embodiment of the present disclosure includes: installing an angle sensor at each of a first end of a first magnetic screw and a third end of a second magnetic screw, where the first magnetic screw further includes a second end opposite to the first end, and the second magnetic screw further includes a fourth end opposite to the third end: aligning each of the first end and the third end at a reference angle 0° using the angle sensor; aligning each of the first magnetic screw and the second magnetic screw at a rotation angle; and rotating the first magnetic screw and the second magnetic screw.

In an embodiment, when the angle of the first end is the reference angle 0°, an angle of the second end may be calculated using following Equation 1: a=L1/P1*(−360). In Equation 1, “a” may be the angle of the second end, L1 may be a length of the first magnetic screw, and P1 may be a pitch of the first magnetic screw. When the angle of the third end is the reference angle 0°, an angle of the fourth end may be calculated using following Equation 2: b=L2/P2*(−360). In Equation 2, “b” may be the angle of the fourth end, L2 may be a length of the second magnetic screw, and P2 may be a pitch of the second magnetic screw.

In an embodiment, when the first magnetic screw rotates, the rotation angle of the second magnetic screw may be calculated using following Equation 3: c=x+t/P*360. In Equation 3, “c” may be the angle of the fourth end, “x” may be the angle of the first end, “t” may be a distance between the first magnetic screw and the second magnetic screw, and P may be the pitch of each of the first magnetic screw and the second magnetic screw, and the pitch of the second magnetic screw may be the same as the pitch of the first magnetic screw.

In an embodiment, the magnetic levitation transport method may further include aligning each of the first end and the third end at the reference angle 0° before the installing the angle sensor.

In an embodiment, in the magnetic levitation transport method, a motor may be connected to each of the second end and the fourth end and rotate each of the first magnetic screw and the second magnetic screw.

In an embodiment, in the magnetic levitation transport method, a first chamber and a second chamber disposed in one direction from the first chamber may be provided. The first magnetic screw may be disposed in the first chamber, and the second magnetic screw may be disposed in the second chamber.

In an embodiment, in the magnetic levitation transport method, a magnetic nut movable in the one direction and a carrier connected to the magnetic nut may be provided.

In an embodiment, in the rotating of the first magnetic screw and the second magnetic screw, the magnetic nut and the carrier may be movable on the first magnetic screw and the second magnetic screw in the one direction.

In an embodiment, each of the first magnetic screw and the second magnetic screw may include a magnet forming an outer surface.

In an embodiment, the magnet may include a south pole and a north pole alternately arranged along the one direction.

In a magnetic levitation transport system according to embodiments of the present disclosure, the system may include magnetic screws each connected to an angle sensor. An angle of each of the magnetic screws may be automatically controlled by calculating a relationship between the magnetic screws adjacent to each other. Accordingly, transport of the carrier may be controlled outside chambers, and impact and vibration to the carrier that may occur during transport process may be minimized. That is, since a step of manually adjusting the angle of each of the magnetic screws is not required, time of the transport process may be shortened and efficiency of the magnetic levitation transport system may be effectively improved.

### BRIEF DESCRIPTION OF THE DRAWINGS

FIGS. 1 and 2 are diagrams illustrating a magnetic levitation transport system according to an embodiment of the present disclosure.

FIGS. 3 to 9 are diagrams illustrating a magnetic levitation transport method according to an embodiment of the present disclosure.

FIG. 10 is a diagram illustrating a magnetic levitation transport system according to another embodiment of the present disclosure.

FIG. 11 is a diagram illustrating a magnetic levitation transport method according to another embodiment of the present disclosure.

### DETAILED DESCRIPTION

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Hereinafter, display devices in accordance with embodiments will be described in more detail with reference to the accompanying drawings. The same reference numerals are used for the same components in the drawings, and redundant descriptions of the same components will be omitted.

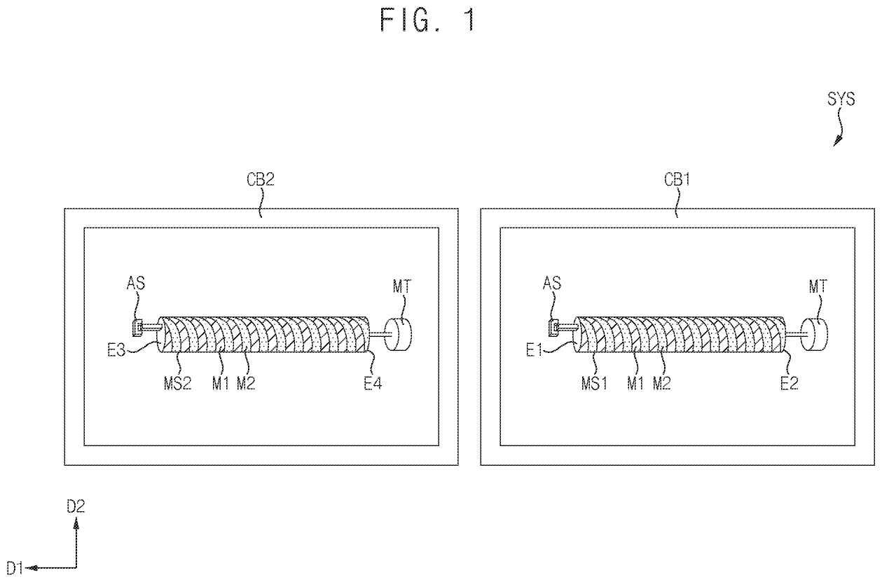

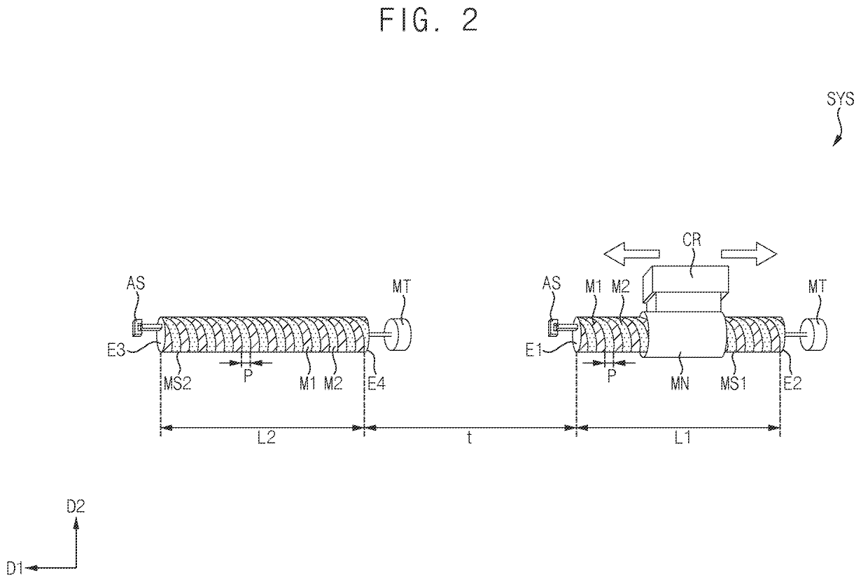

FIGS. 1 and 2 are diagrams illustrating a magnetic levitation transport system according to an embodiment of the present disclosure.

Referring to FIGS. 1 and 2, a magnetic levitation transport system SYS may include a first chamber CB1, a second chamber CB2, a first magnetic screw MS1, a second magnetic screw MS2, an angle sensor AS, a motor MT, a magnetic nut MN and a carrier CR.

The first chamber CB1 and the second chamber CB2 may be adjacent to each other. For example, the second chamber CB2 may be adjacent to the first chamber CB1 in a first direction D1. Each of the first chamber CB1 and the second chamber CB2 may include an inner space.

The first magnetic screw MS1 may be disposed in the inner space of the first chamber CB1. The second magnetic screw MS2 may be disposed in the inner space of the second chamber CB2. Each of the first magnetic screw MS1 and the second magnetic screw MS2 may have a cylindrical shape extending in the first direction D1.

The first magnetic screw MS1 may have a first length L1, and the second magnetic screw MS2 may have a second length L2. The first length L1 may be defined as a length of the first magnetic screw MS1 in the first direction D1, and the second length L2 may be defined as a length of the second magnetic screw MS2 in the first direction D1.

The first magnetic screw MS1 may include a first end E1 and a second end E2, which are opposite to each other. For example, the first end E1 may be spaced apart from the second end E2 in the first direction D1. The second magnetic screw MS2 may include a third end E3 and a fourth end E4, which are opposite to each other. For example, the third end E3 may be spaced apart from the fourth end E4 in the first direction D1. That is, the third end E3 may be disposed farther away from the first magnetic screw MS1 than the fourth E4 is disposed, and the fourth end E4 may be disposed closer to the first magnetic screw MS1 than the third end E3 is disposed.

Each of the first magnetic screw MS1 and the second magnetic screw MS2 may include a magnet. For example, the magnet may be a permanent magnet. The magnet may form an outer surface of each of the first magnetic screw MS1 and the second magnetic screw MS2.

The magnet may include a first magnet M1 and a second magnet M2 having different polarities. For example, the first magnet M1 may have a south (S) pole and the second magnet M2 may have a north (N) pole. The first magnet M1 and the second magnet M2 may be alternately arranged in a spiral shape. That is, the first magnet M1 and the second magnet M2 may serve as threads of the first magnetic screw MS1 and the second magnetic screw MS2. In other words, each of the first magnet M1 and the second magnet M2 may have a spiral shape forming the outer surfaces of the first magnetic screw MS1 and the second magnetic screw MS2.

A pitch P may be defined as a width of the first magnet M1 or the second magnet M2 in the first direction D1 in each of the first magnetic screw MS1 and the second magnetic screw MS2. That is, the pitch P may be a distance between the first magnet M1 and the second magnet M2 adjacent to each other in each of the first magnetic screw MS1 and the second magnetic screw MS2.

A separation distance t may be defined as a distance between the first magnetic screw MS1 and the second magnetic screw MS2. Specifically, the separation distance t may be a distance from the first end E1 of the first magnetic screw MS1 to the fourth end E4 of the second magnetic screw MS2 in the first direction D1.

The angle sensor AS may be connected to one surface of each of the first magnetic screw MS1 and the second magnetic screw MS2. Specifically, the angle sensors AS may be connected to the first end E1 of the first magnetic screw MS1, and may connected to the third end E3 of the second magnetic screw MS2, respectively. The angle sensor AS may include a protrusion part protruding from each of the first end E1 and the third end E3 and a sensor that recognizes the protrusion part. For example, the angle sensor AS may be a horseshoe photo sensor for vacuum, but the present disclosure is not limited thereto.

In addition, although FIGS. 1 and 2 illustrate that the protrusion part of the angle sensor AS protrudes in the first direction D1 and has a rectangular cross-sectional shape, the present disclosure is not limited thereto. For example, the protrusion part may protrude in various directions and may have various shapes.

The angle sensor AS may recognize a predetermined portion of each of the first magnetic screw MS1 and the second magnetic screw MS2. Specifically, the angle sensor AS may recognize a predetermined portion of each of the first end E1 and the third end E3. A position of the predetermined portion of each of the first end E1 and the third end E3 recognized by the angle sensor AS may be preset.

When the angle sensor AS recognizes the predetermined portion of each of the first end E1 and the third end E3, an angle of each of the first end E1 and the third end E3 may be defined as reference angle 0°. Accordingly, each part of the first magnetic screw MS1 and the second magnetic screw MS2 may have an angle of about 0° to about 360° with respect to the reference angle 0°. That is, each part of the first magnetic screw MS1 and the second magnetic screw MS2 may be rotated at the angle of about 0° to about 360° with respect to the central axis of the first magnetic screw MS1 and the second magnetic screw MS2, which is parallel to the first direction DR1. When the angle of each of the first end E1 and the third end E3 is the reference angle 0°, it may be defined that each of the first magnetic screw MS1 and the second magnetic screw MS2 has reference angle 0°.

In an embodiment, when the angle of the first end E1 is reference angle 0°, an angle of the second end E2 may satisfy Equation 1 below. In addition, when the angle of the third end E3 is reference angle 0°, an angle of the fourth end E4 may satisfy Equation 2 below:

$$a = L 1 / P * ( - 3 \; 60 ) , \qquad [ Equation 1 ]$$

In Equation 1, “a” may be the angle of the second end E2 of the first magnetic screw MS1, L1 may be the first length L1 of the first magnetic screw MS1, and P may be the pitch of the first magnetic screw MS1.

$$b = L 2 / p * ( - 3 \; 60 ) , \qquad [ Equation 2 ]$$

In Equation 2, “b” may be the angle of the fourth end E4 of the second magnetic screw MS2, L2 may be the second length L2 of the second magnetic screw MS2, and P may be the pitch of the second magnetic screw MS2. The pitch of the second magnetic screw MS2 may be the same as the pitch of the first magnetic screw MS1.

The motor MT may be connected to one surface of each of the first magnetic screw MS1 and the second magnetic screw MS2. Specifically, the motors MT may be connected to the second end E2 of the first magnetic screw MS1, and may be connected to the fourth end E4 of the second magnetic screw MS2, respectively. The motor MT may rotate each of the first magnetic screw MS1 and the second magnetic screw MS2 with respect to a central axis of the first magnetic screw MS1 and the second magnetic screw MS2, which is parallel to the first direction DR1.

The magnetic nut MN may surround at least a portion of each of the first magnetic screw MS1 and the second magnetic screw MS2. For example, the magnetic nut MN may have a hollow cylindrical shape. The magnetic nut MN may be movable on the first magnetic screw MS1 and the second magnetic screw MS2. In other words, the magnetic nut MN may move from the first magnetic screw MS1 to the second magnetic screw MS2, and may move from the second magnetic screw MS2 to the first magnetic screw MS1. That is, the magnetic nut MN may be movable in the first direction D1 or in a direction opposite to the first direction D1.

The magnetic nut MN may include a magnet. The magnet may form an inner surface of the magnetic nut MN. Accordingly, magnetic force may be generated between the magnet forming the inner surface of the magnetic nut MN and the magnet forming the outer surface of each of the first magnetic screw MS1 and the second magnetic screw MS2. Due to the magnetic force, the magnetic nut MN may not contact the first magnetic screw MS1 and the second magnetic screw MS2. That is, the magnetic nut MN may maintain a state of being constantly spaced apart from the first magnetic screw MS1 and the second magnetic screw MS2.

In addition, when each of the first magnetic screw MS1 and the second magnetic screw MS2 is rotated by the motor MT, the magnetic nut MN may be movable in the first direction D1 or in the direction opposite to the first direction D1 along the first magnetic screw MS1 and the second magnetic screw MS2 by the magnetic force.

When the magnetic nut MN is moved by rotation of the first magnetic screw MS1 and the second magnetic screw MS2, each of the first magnetic screw MS1 and the second magnetic screw MS2 may be aligned with a rotation angle. The rotation angle may be defined as an angle at which each of the first magnetic screw MS1 and the second magnetic screw MS2 are aligned so that the first magnetic screw MS1 and the second magnetic screw MS2 are treated as one magnetic screw extending in the first direction D1. That is, the first magnet M1 and the second magnet M2 may be arranged as if extending continuously from the first magnetic screw MS1 to the second magnetic screw MS2. In other words, the rotation angle may be defined as each of an angle of the second end E2 and an angle of the fourth end E4, to which the motor MT that rotates the first magnetic screw MS1 and the second magnetic screw MS2 is connected.

In an embodiment, the second magnetic screw MS2 may be aligned and rotated based on an angle of the first magnetic screw MS1. The rotation angle of the second magnetic screw MS2 may satisfy Equation 3 below:

$$c = x + t / P * 360. \qquad [ Equation 3 ]$$

In Equation 3, “c” may be the angle of the fourth end E4 of the second magnetic screw MS2, “x” may be the angle of the first end E1 of the first magnetic screw MS1, “t” may be the separation distance between the first magnetic screw MS1 and the second magnetic screw MS2, and P may be the pitch of each of the first magnetic screw and the second magnetic screw.

That is, the angle of the fourth end E4 may be determined based on the angle of the first end E1. In other words, the rotation angle of the second magnetic screw MS2 may be determined based on the rotation angle of the first magnetic screw MS1.

The carrier CR may be connected to the magnetic nut MN. For example, the carrier CR may be disposed on the magnetic nut MN, and may extend in a second direction D2. The second direction D2 may be perpendicular to the first direction D1. The carrier CR may be transported in the first direction D1 or in the direction opposite to the first direction D1 through the magnetic nut MN. That is, the carrier CR may be transported in a magnetic levitation method through the magnetic nut MN.

The magnetic levitation transport system SYS according to an embodiment of the present disclosure may include the magnetic screws MS1 and MS2 connected to the angle sensors AS, respectively. The angle of each of the magnetic screws MS1 and MS2 may be automatically controlled by calculating a relationship between the magnetic screws MS1 and MS2 adjacent to each other. Accordingly, transport of the carrier CR may be controlled outside the chambers CB1 and CB2, and impact and vibration to the carrier CR that may occur during transport process may be effectively minimized. That is, since a step of manually adjusting the angle of each of the magnetic screws MS1 and MS2 may not be necessary, efficiency of the magnetic levitation transport system SYS may be effectively improved.

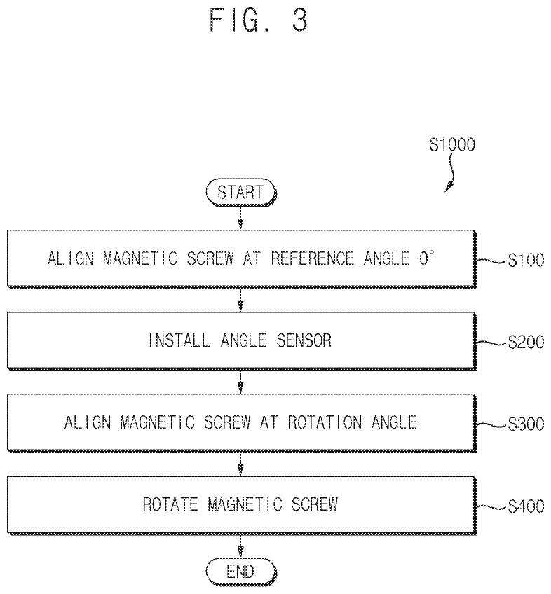

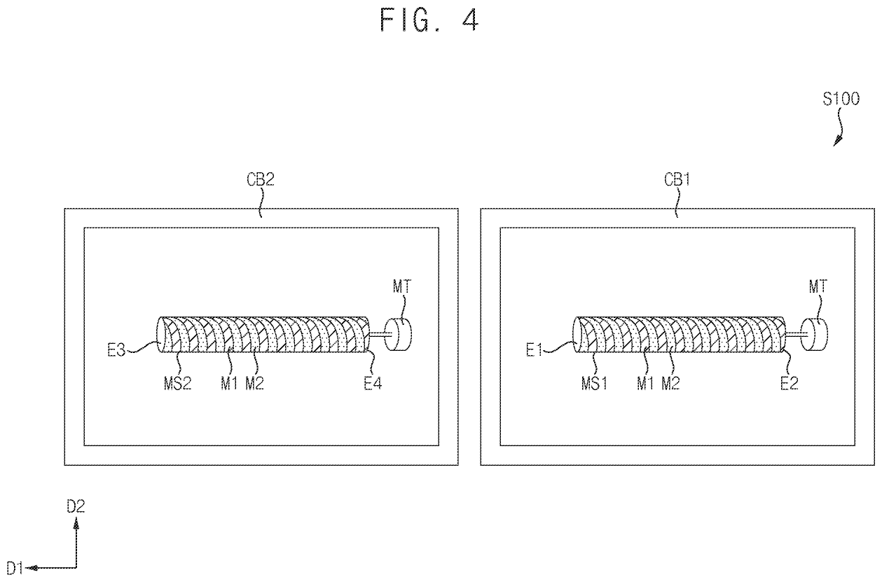

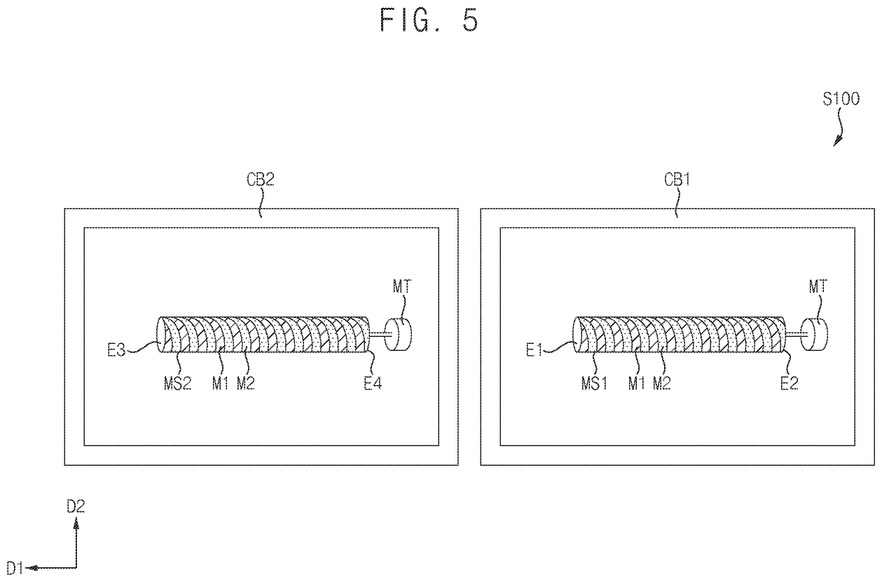

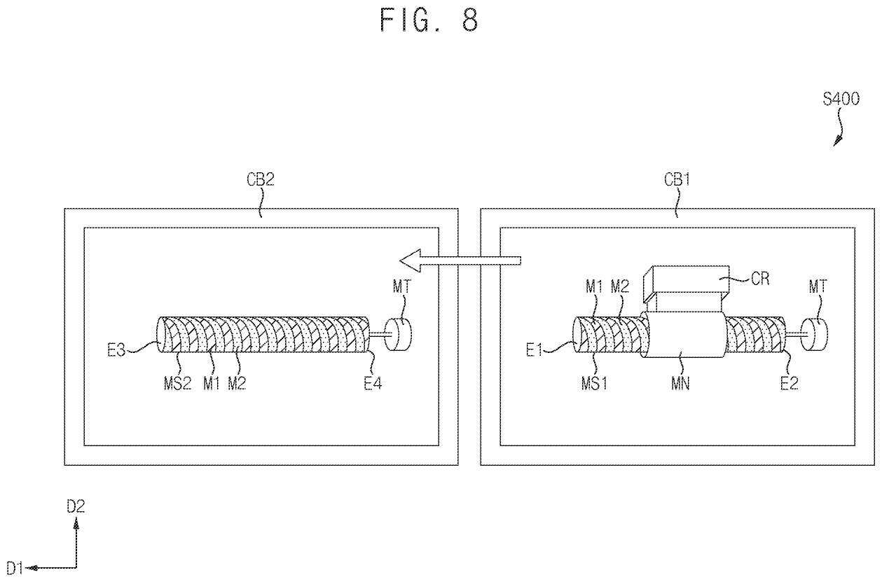

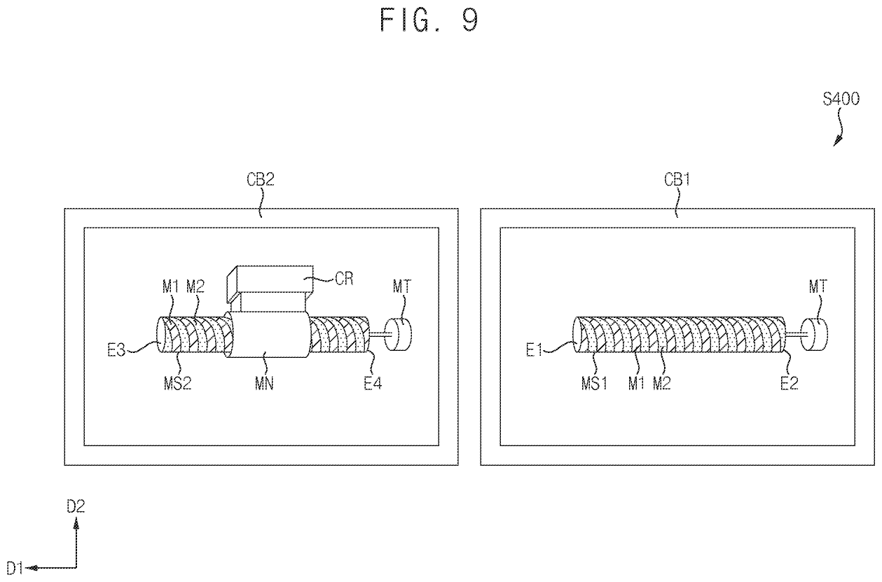

FIGS. 3 to 9 are diagrams illustrating a magnetic levitation transport method according to an embodiment of the present disclosure.

A magnetic levitation transport method (S1000) described with reference to FIGS. 3 to 9 may be performed using the magnetic levitation transport system SYS described with reference to FIGS. 1 and 2. Therefore, redundant descriptions will be omitted or simplified.

Referring to FIGS. 3, 4 and 5, in the magnetic levitation transport method (S1000) using the magnetic levitation transport system SYS, each of the first magnetic screw MS1 and the second magnetic screw MS2 may be aligned at reference angle 0° (S100).

In the aligning of each of the first magnetic screw MS1 and the second magnetic screw MS2 at reference angle 0° (S100), each of the first end E1 and the third end E3 may be aligned at the reference angle 0°. That is, each of the first end E1 and the third end E3, which is configured to be ranged from about 0° to about 360°, may be aligned at the reference angle 0°.

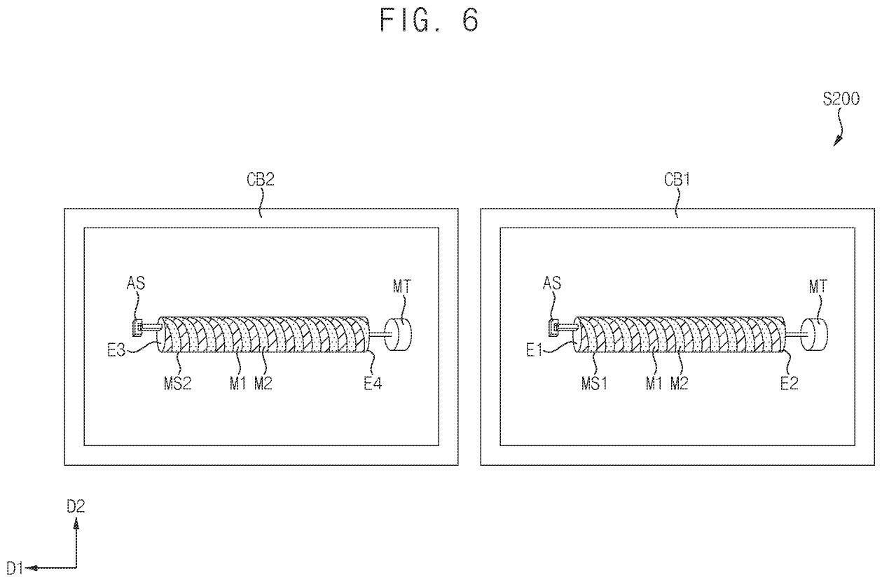

Referring to FIGS. 3 and 6, in the magnetic levitation transport method (S1000) using the magnetic levitation transport system SYS, the angle sensor AS may be installed (S200).

In the installing of the angle sensor AS (S200), the angle sensor AS may be connected to each of the first magnetic screw MS1 and the second magnetic screw MS2. Specifically, the angle sensors AS may be installed to be connected to the first end E1 and the third end E3, respectively.

The angle sensor AS may recognize whether each of the first magnetic screw MS1 and the second magnetic screw MS2 is aligned at the reference angle 0° by recognizing a predetermined portion of each of the first end E1 and the third end E3.

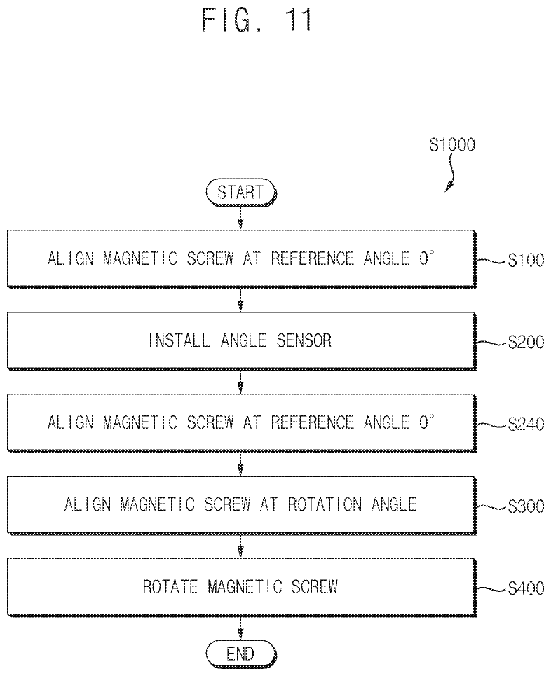

When each of the first magnetic screw MS1 and the second magnetic screw MS2 is not aligned at the reference angle 0°, each of the first magnetic screw MS1 and the second magnetic screw MS2 may be rotated to have the reference angle 0° (S240). That is, each of the first magnetic screw MS1 and the second magnetic screw MS2 may be rotated so that the angle sensor AS recognizes the portion of each of the first end E1 and the third end E3. Accordingly, each of the first magnetic screw MS1 and the second magnetic screw MS2 may be aligned to have the reference angle 0°. (See FIG. 11)

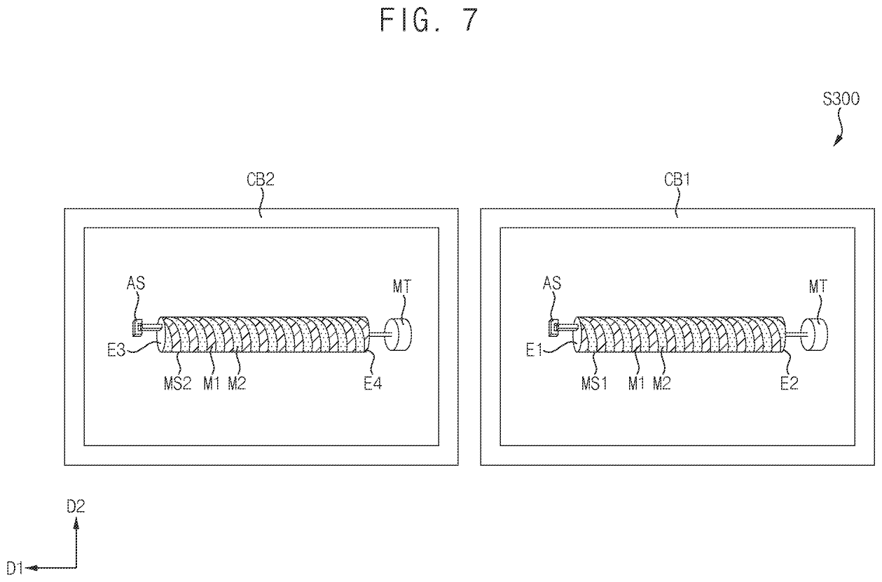

Referring to FIGS. 3 and 7, in the magnetic levitation transport method (S1000) using the magnetic levitation transport system SYS, each of the first magnetic screw MS1 and the second magnetic screw MS2 may be aligned at the rotation angle (S300).

In the aligning of each of the first magnetic screw MS1 and the second magnetic screw MS2 at the rotation angle (S300), the second magnetic screw MS2 may be aligned based on the rotation angle of the first magnetic screw MS1. In other words, the angle of the fourth end E4 may be determined based on the angle of the first end E1. Accordingly, each of the first magnetic screw MS1 and the second magnetic screw MS2 may be aligned so that the first magnetic screw MS1 and the second magnetic screw MS2 may be treated as one magnetic screw extending in the first direction D1.

Referring to FIGS. 3, 8 and 9, in the magnetic levitation transport method (S1000) using the magnetic levitation transport system SYS, each of the first magnetic screw MS1 and the second magnetic screw MS2 may rotate (S400).

In the rotating of the first magnetic screw MS1 and the second magnetic screw MS2 (S400), the motor MT may rotate each of the first magnetic screw MS1 and the second magnetic screw MS2. Accordingly, the magnetic nut MN and the carrier CR may be moved in a magnetic levitation method. For example, the magnetic nut MN and the carrier CR may be transported from the first chamber CB1 to the second chamber CB2. That is, the magnetic nut MN and the carrier CR may be transported from the first magnetic screw MS1 to the second magnetic screw MS2.

As each of the first magnetic screw MS1 and the second magnetic screw MS2 may be aligned and rotated at the rotation angle, the first magnetic screw MS1 and the second magnetic screw MS2 may be treated as one magnetic screw. In other words, even while the first magnetic screw MS1 and the second magnetic screw MS2 rotate, the first magnet M1 and the second magnet M2 may be arranged to continuously extend from the first magnetic screw MS1 to the second magnetic screw MS2.

Assuming that the first magnetic screw MS1 and the second magnetic screw MS2 are not aligned at the rotation angle before the rotating the first magnetic screw MS1 and the second magnetic screw MS2, impact and vibration may occur in the magnetic nut MN and the carrier CR that are transported by rotation of the first magnetic screw MS1 and the second magnetic screw MS2.

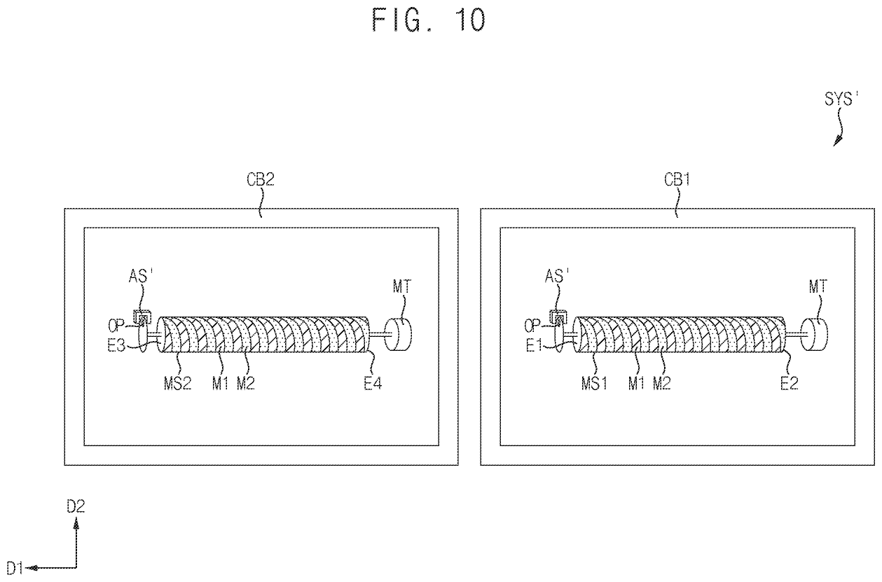

FIG. 10 is a diagram illustrating a magnetic levitation transport system according to another embodiment of the present disclosure.

A magnetic levitation transport system SYS' described with reference to FIG. 10 may be substantially the same as or similar to the magnetic levitation transport system SYS described with reference to FIGS. 1 and 2, except for an angle sensor AS′. Therefore, redundant descriptions will be omitted or simplified.

Referring to FIG. 10, the magnetic levitation transport system SYS' may include the first chamber CB1, the second chamber CB2, the first magnetic screw MS1, the second magnetic screw MS2, the angle sensor AS' and the motor MT.

The first magnetic screw MS1 may be disposed in the inner space of the first chamber CB1, and the second magnetic screw MS2 may be disposed in the inner space of the second chamber CB2.

The first magnetic screw MS1 may include the first end E1 and the second end E2, and the second magnetic screw MS2 may include the third end E3 and the fourth end E4. In addition, each of the first magnetic screw MS1 and the second magnetic screw MS2 may include the first magnet M1 and the second magnet M2 forming the outer surfaces. The first magnet M1 and the second magnet M2 may be alternately arranged in a spiral shape. The first magnetic screw MS1 and the second magnetic screw MS2 may rotate through the motor MT connected to the second end E2 and the fourth end E4, respectively.

The angle sensor AS' may be connected to each of the first end E1 of the first magnetic screw MS1 and the third end E3 of the second magnetic screw MS2. The angle sensor AS' may include a protrusion part protruding from each of the first end E1 and the third end E3 and a sensor that recognizes the protrusion part.

In an embodiment, the protrusion part may include a disk shape. In addition, an opening OP penetrating a portion of the disk shape may be defined in the protrusion part. The sensor may recognize the opening OP. Accordingly, the angle sensor AS' may recognize whether each of the first magnetic screw MS1 and the second magnetic screw MS2 is aligned at reference angle 0°.

The present disclosure can be applied to a manufacturing process of various display devices. For example, the present disclosure is applicable to a manufacturing process of various display devices such as display devices for vehicles, ships and aircraft, portable communication devices, display devices for exhibition or information transmission, medical display devices, and the like.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A magnetic levitation transport system, the system comprising:
a first magnetic screw including a first end and a second end, which are opposite to each other; and
a second magnetic screw disposed in one direction from the first magnetic screw and including a third end and a fourth end, which are opposite to each other,
wherein the third end is disposed farther from the first magnetic screw than the fourth end is disposed,
wherein an angle of the fourth end is determined based on an angle of the first end.

2. The system of claim 1, wherein when the angle of the first end is a reference angle 0°, an angle of the second end is calculated using following Equation 1:
$$a = L 1 / P 1 * ( - 3 \; 60 ) ,$$
wherein a is the angle of the second end, L1 is a length of the first magnetic screw, and P1 is a pitch of the first magnetic screw, and
when an angle of the third end is the reference angle 0°, the angle of the fourth end is calculated using following Equation 2:
$$b = L 2 / P 2 * ( - 3 \; 60 ) ,$$
wherein b is the angle of the fourth end, L2 is a length of the second magnetic screw, and P2 is a pitch of the second magnetic screw.

3. The system of claim 2, wherein when the first magnetic screw rotates, a rotation angle of the second magnetic screw is calculated using following Equation 3:
$$c = x + t / P * 360 ,$$
wherein c is the angle of the fourth end, x is the angle of the first end, t is a distance between the first magnetic screw and the second magnetic screw, and P is the pitch of each of the first magnetic screw and the second magnetic screw, and the pitch of the second magnetic screw is the same as the pitch of the first magnetic screw.

4. The system of claim 1, further comprising:
an angle sensor connected to each of the first end and the third end.

5. The system of claim 1, further comprising:
a motor connected to each of the second end and the fourth end.

6. The system of claim 1, further comprising:
a magnetic nut movable in the one direction on the first magnetic screw and the second magnetic screw.

7. The system of claim 6, further comprising:
a carrier connected to the magnetic nut.

8. The system of claim 1, further comprising:
a first chamber; and
a second chamber disposed in the one direction from the first chamber,
wherein the first magnetic screw is disposed in the first chamber, and the second magnetic screw is disposed in the second chamber.

9. The system of claim 1, wherein each of the first magnetic screw and the second magnetic screw includes a magnet forming an outer surface.

10. The system of claim 9, wherein the magnet includes a south pole and a north pole alternately arranged along the one direction.

11. A magnetic levitation transport method, the method comprising:
installing an angle sensor at each of a first end of a first magnetic screw and a third end of a second magnetic screw, wherein the first magnetic screw further includes a second end opposite to the first end, and the second magnetic screw further includes a fourth end opposite to the third end;
aligning each of the first end and the third end at a reference angle 0° using the angle sensor;
aligning each of the first magnetic screw and the second magnetic screw at a rotation angle; and
rotating the first magnetic screw and the second magnetic screw.

12. The method of claim 11, wherein when the angle of the first end is the reference angle 0°, an angle of the second end is calculated using following Equation 1:
$$a = L 1 / P 1 * ( - 3 \; 60 ) ,$$
wherein a is the angle of the second end, L1 is a length of the first magnetic screw, and P1 is a pitch of the first magnetic screw, and
when the angle of the third end is the reference angle 0°, an angle of the fourth end is calculated using following Equation 2:
$$b = L 2 / P 2 * ( - 3 \; 60 ) ,$$
wherein b is the angle of the fourth end, L2 is a length of the second magnetic screw, and P2 is a pitch of the second magnetic screw.

13. The method of claim 12, wherein when the first magnetic screw rotates, the rotation angle of the second magnetic screw is calculated using following Equation 3:
$$c = x + t / P * 360 ,$$
wherein c is the angle of the fourth end, x is the angle of the first end, t is a distance between the first magnetic screw and the second magnetic screw, and P is the pitch of each of the first magnetic screw and the second magnetic screw, and the pitch of the second magnetic screw is the same as the pitch of the first magnetic screw.

14. The method of claim 11, further comprising:
aligning each of the first end and the third end at the reference angle 0° before the installing the angle sensor.

15. The method of claim 11, wherein:
a motor is connected to each of the second end and the fourth end and rotates each of the first magnetic screw and the second magnetic screw.

16. The method of claim 11, wherein:
a first chamber and a second chamber disposed in one direction from the first chamber are provided,
wherein the first magnetic screw is disposed in the first chamber, and the second magnetic screw is disposed in the second chamber.

17. The method of claim 16, wherein:
a magnetic nut movable in the one direction and a carrier connected to the magnetic nut are provided.

18. The method of claim 17, wherein in the rotating of the first magnetic screw and the second magnetic screw, the magnetic nut and the carrier are movable on the first magnetic screw and the second magnetic screw in the one direction.

19. The method of claim 11, wherein each of the first magnetic screw and the second magnetic screw includes a magnet forming an outer surface.

20. The method of claim 19, wherein the magnet includes a south pole and a north pole alternately arranged along the one direction.
